(19) United States
(12) Patent Application Publication
(10) Pub. No.: US 2025/0341735 A1
(43) Pub. Date: Nov. 6, 2025

(54) ORTHOKERATOLOGY LENS

(71) Applicant: Shanghai FULO Medical Instrument Co., Ltd., Shanghai (CN)

(72) Inventors: Baoguang JIANG, Shanghai (CN); Mototora KAI, Shanghai (CN); An LI, Shanghai (CN)

(73) Assignee: Shanghai FULO Medical Instrument Co., Ltd., Shanghai (CN)

(21) Appl. No.: 18/893,742

(22) Filed: Sep. 23, 2024

(30) Foreign Application Priority Data
May 6, 2024 (CN) 202410551883.9

(51) Int. Cl. G02C 7/04

(52) U.S. Cl. CPC G02C 7/047; G02C 7/049

(57) ABSTRACT

The present disclosure provides an orthokeratology lens. The orthokeratology lens includes a base curve zone, and a reverse curve zone, an adaptation curve zone, and a peripheral curve zone that are successively formed outward from a periphery of the base curve zone. A space defined between the reverse curve zone and a cornea varies periodically in a circumferential direction, and includes small spaces and large spaces that are cyclically and alternately disposed. Therefore, negative pressures applied on the cornea are different. As a result, a defocusing ring formed at a periphery in the cornea is not uniformly distributed. In comparison with a conventional orthokeratology lens, the orthokeratology lens of the present disclosure can produce higher-order aberrations during retinal imaging, which is more effective in slowing down growth of eye axes.

### CROSS-REFERENCE TO RELATED APPLICATIONS

This application claims priority to Chinese Patent Application No. 202410051883.9 with a filing date of May 6, 2024. The content of the aforementioned applications, including any intervening amendments thereto, are incorporated herein by reference.

### TECHNICAL FIELD

The present disclosure relates to the technical field of orthokeratology lenses, and in particular to an orthokeratology lens.

### BACKGROUND

The orthokeratology lens is a corneal contact lens having high hardness and good breathability. The orthokeratology lens is made of a special high oxygen permeable material, and is used to provide temporary vision correction and effectively control myopia progression. The orthokeratology lens includes a base curve zone, a reverse curve zone, an adaptation curve zone, and a peripheral curve zone from a center to the outside, each of which has unique functions and design requirements.

The specific working principle of the orthokeratology lens lies in that a shape of the base curve zone does not match a shape of a center of a cornea. Due to this special design, when eyes are closed, the orthokeratology lens may apply a pressure on the cornea under a pressure of an eyelid, a curvature of the cornea is slightly changed, to implement temporary correction of refractive errors. After long-term wearing of the orthokeratology lens, especially during nighttime sleep, a myopic defocusing ring is formed at a periphery of the cornea due to the special design of the reverse curve zone. Due to the myopic defocusing ring, an imaging band formed on a retina has a specific aberration, which helps to slow down growth of eye axes, thereby controlling myopia progression.

In the design of a conventional orthokeratology lens, the reverse curve zone is usually a narrow circular ring structure. Due to the myopic defocusing ring formed at the periphery of the cornea, spherical aberrations are primarily introduced, and a small amount of higher-order aberrations are introduced. Although the spherical aberrations play a major role in slowing down the growth of the eye axes, the higher-order aberrations also play an active role. However, due to the design constraints, the conventional orthokeratology lens is limited in a capability of introducing the higher-order aberrations. This is because irregularity of the cornea rather than a structure of the orthokeratology lens. Therefore, a defocusing ring formed at the periphery of the cornea by the conventional orthokeratology lens produces a great defocusing amount by increasing a volume of a cavity in the reverse curve zone, and the spherical aberrations during retinal imaging are increased. However, a change in the higher-order aberration during retinal imaging is slight.

### SUMMARY OF PRESENT INVENTION

In view of this, an objective of the present disclosure is to provide an orthokeratology lens, to resolve the foregoing technical problems in the background.

The present disclosure provides an orthokeratology lens. The orthokeratology lens includes a base curve zone, and a reverse curve zone, an adaptation curve zone, and a peripheral curve zone that are successively formed outward from a periphery of the base curve zone, where a space defined between the reverse curve zone and a cornea varies periodically in a circumferential direction, and includes small spaces and large spaces that are cyclically and alternately disposed.

Further, an outer edge of the base curve zone is a circle, a radial distance from an outer edge of the reverse curve zone to a center point of the base curve zone varies periodically in a circumferential direction, to enable the reverse curve zone to have, in the circumferential direction, narrow edge zones and wide edge zones that are cyclically and alternately disposed, the narrow edge zone defines the small space, and the wide edge zone defines the large space.

Further, a radial width of the reverse curve zone meets the following formula:

$$W R C = \frac{W R C 1 + W R C 2}{2} + \frac{W R C 1 - W R C 2}{2} \cdot cos ( n \cdot θ ) \qquad Formula 1$$

where, WRC represents a radial width of the reverse curve zone at an angle of θ, WRC1 represents a maximum radial width of the reverse curve zone, WRC2 represents a minimum radial width of the reverse curve zone, n represents a number of cycles, and 0 represents a radial angle rotated starting from a hour hand of three o'clock along an anticlockwise direction.

Further, n≥1.

Further, an outer edge of the reverse curve zone is a circle, a radial distance from an outer edge of the base curve zone to a center point of the reverse curve zone varies periodically in a circumferential direction, to enable the reverse curve zone to have, in the circumferential direction, narrow edge zones and wide edge zones that are cyclically and alternately disposed, the narrow edge zone defines the small space, and the wide edge zone defines the large space.

Further, a radial width of the reverse curve zone meets the following formula:

$$W R C = \frac{W R C 1 + W R C 2}{2} + \frac{W R C 1 - W R C 2}{2} \cdot cos ( n \cdot θ ) \qquad Formula 2$$

where, WRC represents a radial width of the reverse curve zone at an angle of θ, WRC1 represents a maximum radial width of the reverse curve zone, WRC2 represents a minimum radial width of the reverse curve zone, n represents a number of cycles, and θ represents a radial angle rotated starting from a hour hand of three o'clock along an anticlockwise direction

Further, outer edges of the base curve zone and the reverse curve zone are both circles whose center points are coincident with each other, a surface, facing the cornea, of the reverse curve zone is a wave surface, the wave surface has a downtilt surface and an uptilt surface that periodically undulate in the circumferential direction, the downtilt surface defines the small space, and the uptilt surface defines the large space.

Further, a radial curvature radius of the wave surface varies periodically with a change in a circumferential angle.

Further, the radial curvature radius of the wave surface meets the following formula:

$$R ( θ ) = \frac{{R}_{max} + {R}_{min}}{2} - \frac{{R}_{max} - {R}_{min}}{2} \cdot cos ( n \cdot θ ) \qquad Formula 3$$

where, R(θ) represents a radial curvature radius of the wave surface at an angle of θ, Rₘₐₓ represents a maximum radial curvature radius of the wave surface, Rₘᵢₙ represents a minimum radial curvature radius of the wave surface, n represents a number of circles, and θ=[0, 2*π].

Further, n is odd or even.

Compared with the prior art, the present disclosure has the following beneficial effect:

It may be understood that the space defined between the reverse curve zone and the cornea varies periodically in the circumferential direction, and has small spaces and large spaces that are cyclically and alternately disposed. Therefore, negative pressures applied on the cornea are different. As a result, a defocusing ring formed at a periphery in the cornea is not uniformly distributed. In comparison with a conventional orthokeratology lens, the orthokeratology lens of the present disclosure can produce higher-order aberrations during retinal imaging. This is more effective in slowing down growth of eye axes.

### BRIEF DESCRIPTION OF THE DRAWINGS

FIG. 1 is a schematic diagram of a structure of an orthokeratology lens according to Embodiment 1 of the present disclosure;

FIG. 2 is a sectional view of an orthokeratology lens in Embodiment 1 of the present disclosure;

FIG. 3 is a schematic diagram of a structure of an orthokeratology lens according to Embodiment 2 of the present disclosure;

FIG. 4 is a sectional view of the orthokeratology lens in Embodiment 2 of the present disclosure;

FIG. 5 is a schematic diagram of a structure of an orthokeratology lens according to Embodiment 3 of the present disclosure;

FIG. 6 is a schematic diagram of a structure of an orthokeratology lens according to Embodiment 4 of the present disclosure;

FIG. 7 is a schematic diagram of a structure of a wave surface in Embodiment 4 of the present disclosure;

FIG. 8 is a sectional view of the orthokeratology lens in Embodiment 4 of the present disclosure;

FIG. 9 is a sectional view of the orthokeratology lens when a number of circles is even in Embodiment 4 of the present disclosure; and

FIG. 10 is a sectional view of the orthokeratology lens when a number of circles is odd in Embodiment 4 of the present disclosure.

### REFERENCE NUMERALS

10: base curve zone; 20: reverse curve zone; 30: adaptation curve zone; 40: peripheral curve zone; 51: narrow edge zone; 52, wide edge zone; 100: cornea; 60: wave surface; 61, downtilt surface; 62, uptilt surface.

The present disclosure is further described in the following detailed description with reference to the drawings.

### DETAILED DESCRIPTION OF THE EMBODIMENTS

To facilitate the understanding of the present disclosure, the present disclosure is described more completely below with reference to the accompanying drawings. A plurality of embodiments of the present disclosure are shown in the drawings. However, the present disclosure is embodied in various forms without being limited to the embodiments set forth herein. Rather, these embodiments are provided so that the present disclosure of the present disclosure will be understood more thoroughly and comprehensively.

It should be noted that, when a component is fixed to another component, the component may be fixed to the other component directly or via an intermediate component. When a component is connected to another component, the component may be connected to the another component directly or via an intermediate component. The terms “vertical”, “horizontal”, “left”, and “right” and similar expressions used herein are for illustrative purposes only.

Unless otherwise defined, all technical and scientific terms used herein have the same meanings as commonly understood by those skilled in the technical field of the present disclosure. The terms used in the specification of the present disclosure herein are only for the purpose of describing specific embodiments, and are not intended to limit the present disclosure. The term “and/or” used herein includes one or more of the associated items listed.

### Embodiment 1

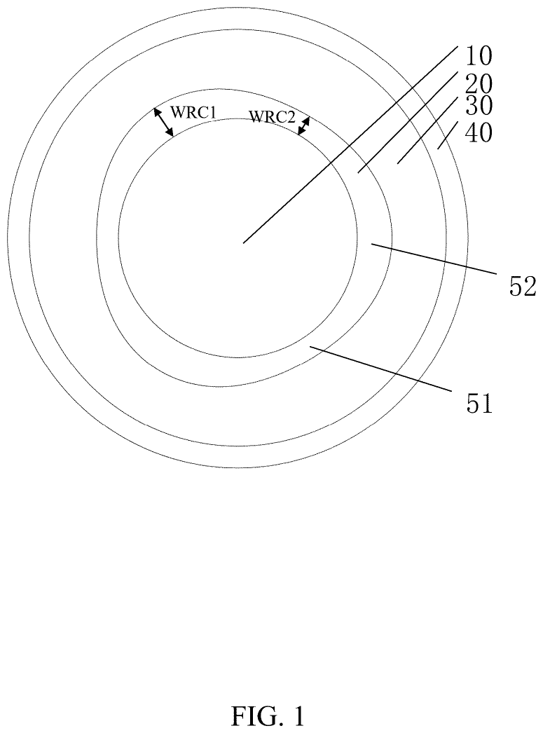

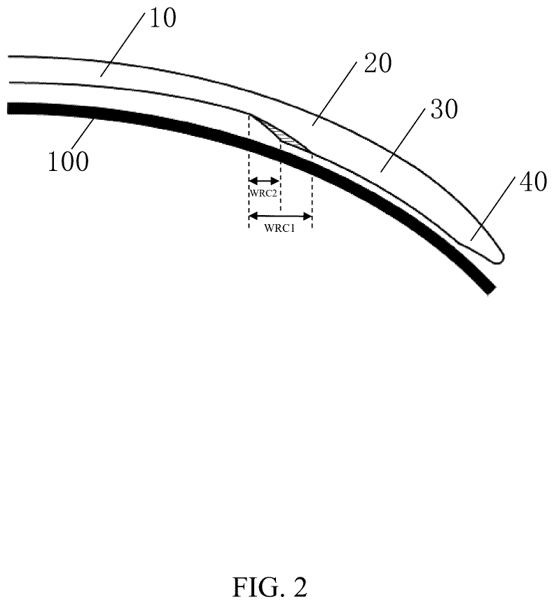

Referring to FIG. 1 and FIG. 2, an orthokeratology lens in Embodiment 1 of the present disclosure includes a base curve zone 10, and a reverse curve zone 20, an adaptation curve zone 30, and a peripheral curve zone 40 that are successively formed outward from a periphery of the base curve zone 10. A space defined between the reverse curve zone 20 and a cornea 100 varies periodically in a circumferential direction, and includes small spaces and large spaces that are cyclically and alternately disposed.

It may be understood that the space defined between the reverse curve zone 20 and the cornea 100 varies periodically in the circumferential direction, and has small spaces and large spaces that are cyclically and alternately disposed. Therefore, negative pressures applied on the cornea 100 are different. As a result, a defocusing ring formed at a periphery in the cornea 100 is not uniformly distributed. In comparison with a conventional orthokeratology lens, the orthokeratology lens of the present disclosure can produce higher-order aberrations during retinal imaging, which is more effective in slowing down growth of eye axes.

Further, an outer edge of the base curve zone 10 is a circle, a radial distance from an outer edge of the reverse curve zone 20 to a center point of the base curve zone 10 varies periodically in the circumferential direction, to enable the reverse curve zone 20 to have, in the circumferential direction, a narrow edge zone 51 and a wide edge zone 52 that are cyclically and alternately disposed. The narrow edge zone 51 defines the small space, and the wide edge zone 52 defines the large space.

It may be understood that in the design of the orthokeratology lens, a volume of a cavity formed between the reverse curve zone 20 and the cornea 100 directly affects the negative pressure applied on the cornea 100. Therefore, in this embodiment, because the reverse curve zone 20 has, in the circumferential direction, the narrow edge zone 51 and the wide edge zone 52 that are cyclically and alternately disposed, for the reverse curve zone 20, a volume of a cavity formed between the wide edge zone 52 and the cornea 100 is large, while a space formed between the narrow edge zone 51 and the cornea 100 is small. Therefore, a negative pressure applied on the cornea 100 in the wide edge zone 52 of the reverse curve zone 20 is greater than a negative pressure applied on the cornea 100 in the narrow edge zone 51 of the reverse curve zone 20. After long-term wearing of the orthokeratology lens, a defocusing ring having an unevenly distributed defocusing amount is formed on an entire anterior surface of the cornea 100, to produce higher-order aberrations for retinal imaging. The higher-order aberrations, especially coma, are deemed to have positive effect on slowing down the growth of the eye axes, thereby helping to improve myopia control.

Further, outer edges of the adaptation curve zone 30 and the peripheral curve zone 40 are both circles whose center points are coincident with a center point of the base curve zone 10. Referring to FIG. 1, in this embodiment, the base curve zone 10 is a circular arc-shaped structure in a central zone of the orthokeratology lens, the reverse curve zone 20 surrounds the base curve zone 10 and is a shaped slightly narrow ring structure, the adaptation curve zone 30 surrounds the reverse curve zone 20 and is a shaped slightly-wide ring structure, and the peripheral curve zone 40 surrounds the adaptation curve zone 30 and is a narrow circular ring structure. A radial distance from an inner edge of the reverse curve zone 20 to a center of the orthokeratology lens does not vary with a change in a circumferential angle, while a radial distance from an outer edge to the center of the orthokeratology lens varies periodically with the change in the circumferential angle. A radial distance from an inner edge of the adaptation curve zone 30 to the center of the orthokeratology lens varies periodically with the change in the circumferential angle, while a radial distance from an outer edge of the adaptation curve zone 30 to the center of the orthokeratology lens does not vary with a change in the circumferential angle.

In addition, it is worth mentioning that because the outer edge of the adaptation curve zone 30 is circular, a radial width of the adaptation curve zone 30 is widest on a profile, with a narrowest radial width, of the reverse curve zone 20, and the radial width of the adaptation curve zone 30 is narrowest on a profile, with a widest radial width, of the reverse curve zone 20. Therefore, while a greater pressure is applied on the reverse curve zone 20, the narrow design of the adaptation curve zone 30 cushions the pressure, to enable the pressure to be evenly distributed on the cornea 100. This prevents an excessive pressure point from being formed on the cornea 100.

Specifically, the radial width of the reverse curve zone 20 meets the following formula:

$$W R C = \frac{W R C 1 + W R C 2}{2} + \frac{W R C 1 - W R C 2}{2} \cdot cos ( n \cdot θ ) \qquad Formula 1$$

where, WRC represents a radial width of the reverse curve zone 20 at an angle of θ, WRC1 represents a maximum radial width of the reverse curve zone 20, WRC2 represents a minimum radial width of the reverse curve zone 20, n represents a number of cycles, and θ represents a radial angle rotated starting from a hour hand of three o'clock along an anticlockwise direction.

It should be noted that in this embodiment, the radial width of the reverse curve zone 20 is equal to a distance from the outer edge of the reverse curve zone 20 to the center point of the base curve zone 10 subtracting a radius of the base curve zone 10. In this embodiment, the radial width of the reverse curve zone 20 varies periodically along the circumferential direction, and meets the formula 1 that a number n of cycles is 3, that is, there are three groups of narrow edge zones 51 and wide edge zones 52 that are cyclically and alternately disposed along the circumferential direction. In the design, adaptability of the orthokeratology lens is increased, so that the orthokeratology lens can better adapt to different parts and shapes of the cornea 100, thereby improving comfort of wearing and shaping effect.

In practical application, to meet individual difference of different corneas 100, an overall volume of the cavity between the reverse curve zone 20 and the cornea 100 may be adjusted by changing a curvature of the reverse curve zone 20, so as to control a spherical aberration produced during retinal imaging. In addition, distribution of the cavity in the reverse curve zone 20 may be adjusted by changing a difference or a number of cycles between the maximum radial width and the minimum radial width of the reverse curve zone 20, so as to control the higher-order aberration during the retinal imaging.

In conclusion, according to the orthokeratology lens in the above embodiments of the present disclosure, the space defined between the reverse curve zone 20 and the cornea 100 varies periodically in the circumferential direction, and has small spaces and large spaces that are cyclically and alternately disposed. Therefore, negative pressures applied on the cornea 100 are different. As a result, a defocusing ring formed at a periphery in the cornea 100 is not uniformly distributed. In comparison with a conventional orthokeratology lens, the orthokeratology lens of the present disclosure can produce higher-order aberrations during retinal imaging, which is more effective in slowing down growth of eye axes.

### Embodiment 2

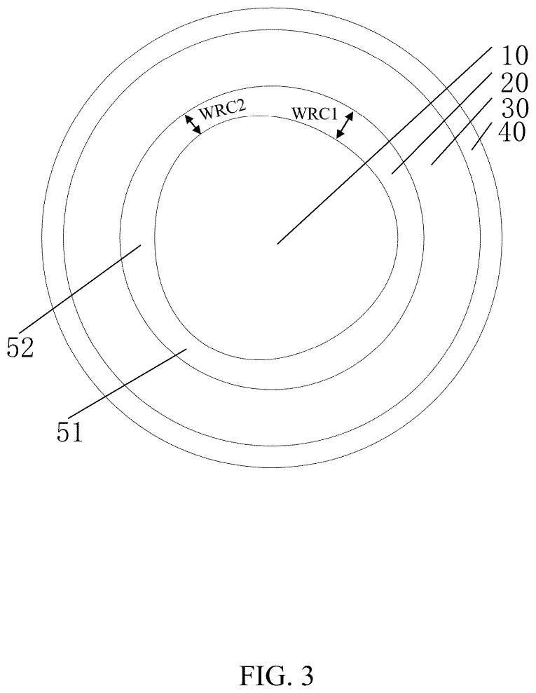

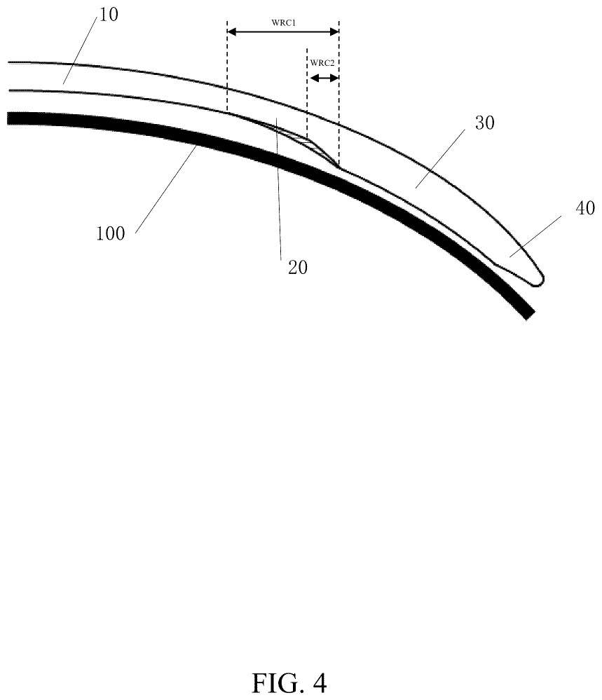

Referring to FIG. 3 and FIG. 4, differences between the orthokeratology lens in the embodiment 2 of the present disclosure and an orthokeratology lens in Embodiment 1 lie in that: An outer edge of a reverse curve zone 20 is a circle, a radial distance from an outer edge of a base curve zone 10 to a center point of the reverse curve zone 20 varies periodically in a circumferential direction, to enable the reverse curve zone 20 to have, in the circumferential direction, a narrow edge zone 51 and a wide edge zone 52 that are cyclically and alternately disposed. The narrow edge zone 51 defines the small space, and the wide edge zone 52 defines the large space. It should be noted that, in this embodiment, deformation is made based on Embodiment 1, and technical effect that is the same as that in Embodiment 1 can be implemented, and thus will not be described in detail.

Further, outer edges of an adaptation curve zone 30 and a peripheral curve zone 40 are both circles whose center points are coincident with a center point of the reverse curve zone 20. Referring to FIG. 3, in this embodiment, the base curve zone 10 is a shaped arc-surface structure in a central zone of the orthokeratology lens. A radial distance from the outer edge of the base curve zone 10 to a center of the orthokeratology lens varies with a change in a circumferential angle. The adaptation curve zone 30 surrounds the reverse curve zone 20 and is a slightly-wider circular ring structure, and a radial distance from an inner edge of the adaptation curve zone 30 to the center of the orthokeratology lens and a radial distance from an outer edge of the adaptation curve zone 30 to the center of the orthokeratology lens do not vary with the change in the circumferential angle. A radial distance from an inner edge of the reverse curve zone 20 to the center of the orthokeratology lens varies periodically with the change in the circumferential angle, while a radial distance from an outer edge of the reverse curve zone 20 to the center of the orthokeratology lens does not vary with the change in the circumferential angle.

In addition, it is worth mentioning that because the outer edge of the reverse curve zone 20 is circular, a radial width of the base curve zone 10 is widest on a profile, with a narrowest radial width, of the reverse curve zone 20, and the radial width of the base curve zone 10 is narrowest on a profile, with a widest radial width, of the reverse curve zone 20. Therefore, while a greater pressure is applied on the reverse curve zone 20, the narrow design of the base curve zone 10 cushions the pressure, to enable the pressure to be evenly distributed on the cornea 100. This prevents an excessive pressure point from being formed on the cornea 100.

Specifically, the radial width of the reverse curve zone 20 meets the following formula:

$$W R C = \frac{W R C 1 + W R C 2}{2} + \frac{W R C 1 - W R C 2}{2} \cdot cos ( n \cdot θ ) \qquad Formula 2$$

where, WRC represents a radial width of the reverse curve zone 20 at an angle of θ, WRC1 represents a maximum radial width of the reverse curve zone 20, WRC2 represents a minimum radial width of the reverse curve zone 20, n represents a number of cycles, and θ represents a radial angle rotated starting from a hour hand of three o'clock along an anticlockwise direction.

It should be noted that in this embodiment, the radial width of the reverse curve zone 20 is equal to a radius of the reverse curve zone 20 subtracting a distance from the outer edge of the base curve zone 10 to the center point of the reverse curve zone 20. In this embodiment, the radial width of the reverse curve zone 20 varies periodically along the circumferential direction, and meets the formula 2 that a number n of cycles is 3, that is, there are three groups of narrow edge zones 51 and wide edge zones 52 that are cyclically and alternately disposed along the circumferential direction. In the design, adaptability of the orthokeratology lens is increased, so that the orthokeratology lens can better adapt to different parts and shapes of the cornea 100, thereby improving comfort of wearing and shaping effect.

### Embodiment 3

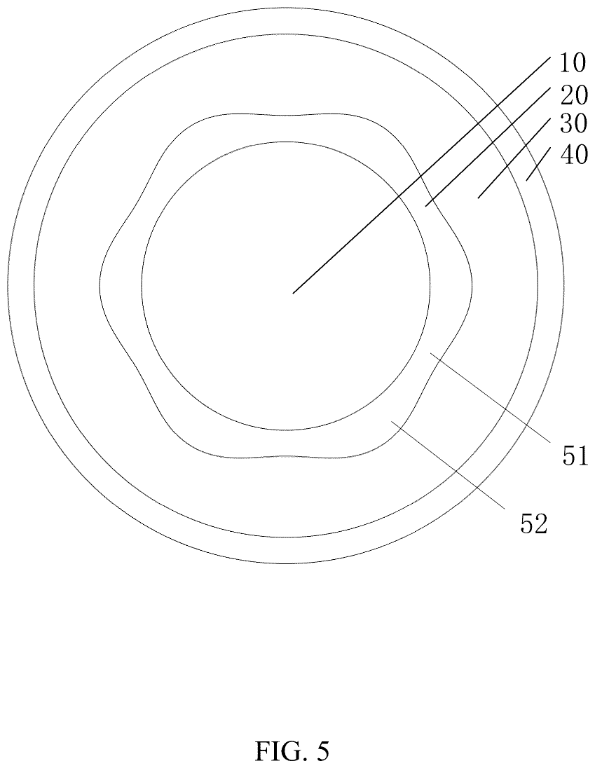

Referring to FIG. 5, differences between an orthokeratology lens in the embodiment 3 of the present disclosure and the orthokeratology lens in Embodiment 1 lie in that: There are six groups of narrow edge zones 51 and wide edge zones 52 of a reverse curve zone 20 that are cyclically and alternately disposed along a circumferential direction. It may be understood that, compared with Embodiment 1, this embodiment has three more groups of numbers of cycles, such that the defocusing ring formed at the periphery in the cornea 100 provides more coma in different directions for retinal imaging. Therefore, myopia control effect is better.

### Embodiment 4

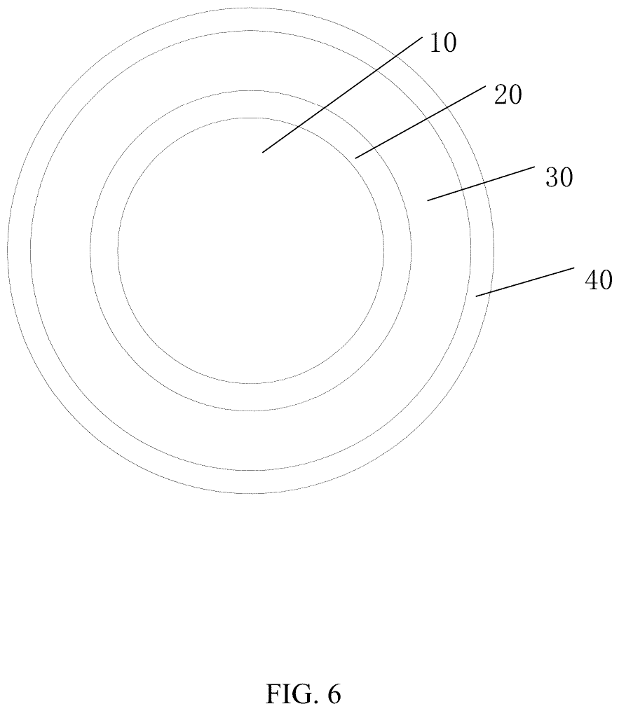

Referring to FIG. 6 to FIG. 10, differences between an orthokeratology lens in the embodiment 4 and the orthokeratology lens in Embodiment 1 in that:

Outer edges of the base curve zone 10 and the reverse curve zone 20 are both circles whose center points are coincident with each other. A surface, facing the cornea 100, of the reverse curve zone 20 is a wave surface 60. The wave surface 60 has a downtilt surface 61 and an uptilt surface 62 that periodically undulate in the circumferential direction. The downtilt surface 61 defines the small space, and the uptilt surface 62 defines the large space.

It may be understood that, in this embodiment, the surface, facing the cornea 100, of the reverse curve zone 20 is designed as a wave surface 60 that periodically undulates, to enable the a space defined between the reverse curve zone 20 and the cornea 100 varies periodically in the circumferential direction. As a result, the defocusing ring formed at the periphery in the cornea 100 is not uniformly distributed. In comparison with a conventional orthokeratology lens, the orthokeratology lens of the present disclosure can produce higher-order aberrations during retinal imaging, which is more effective in slowing down growth of eye axes.

In this embodiment, a radial curvature radius of the wave surface varies periodically with a change in the circumferential angle.

$$R ( θ ) = \frac{{R}_{max} + {R}_{min}}{2} - \frac{{R}_{max} - {R}_{min}}{2} \cdot cos ( n \cdot θ ) \qquad Formula 3$$

where, R(θ) represents a radial curvature radius of the wave surface 60 at an angle of θ, Rₘₐₓ represents a maximum radial curvature radius of the wave surface 60, Rₘᵢₙ represents a minimum radial curvature radius of the wave surface 60, n represents a number of circles, and θ=[0, 2*π].

It should be noted that in this embodiment, a quantity of higher-order aberrations during retinal imaging may be controlled by adjusting a difference or a number of circles between the maximum radial curvature radius and the minimum radial curvature radius of the wave surface 60, to meet different customization needs of corneas.

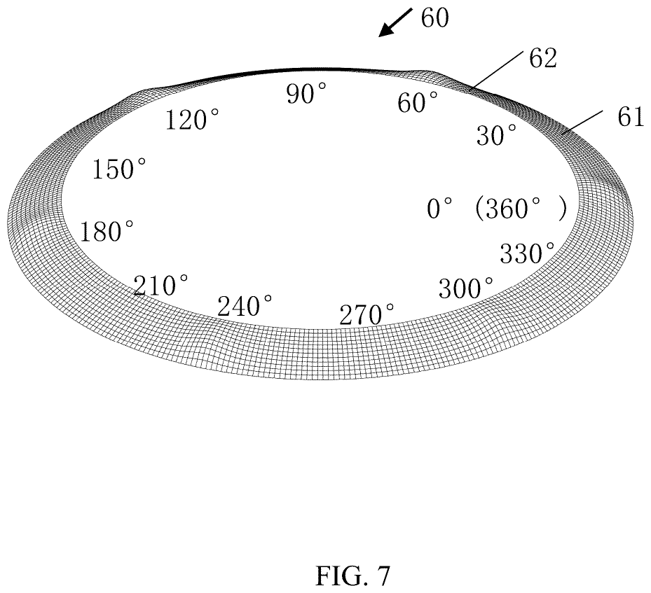

FIG. 7 shows a wave surface 60 with a number n of circles of 6. Radial angles 0° to 60°, 60° to 120°, 120° to 180°, 180° to 240°, 240° to 300°, and 300° to 360° are respectively 1 to 6 variation cycles of the radial curvature radius of the wave surface 60. In each variation cycle, the radial curvature radius of the wave surface is first increased from a minimum radial curvature radius Rₘᵢₙ to a maximum radial curvature radius Rₘₐₓ, and then is decreased from the maximum radial curvature radius Rₘₐₓ to the minimum radial curvature radius Rₘᵢₙ. In an example of a circle of 0° to 60°, 0° to 30° is a downtilt surface, and 30° to 60° is an uptilt surface.

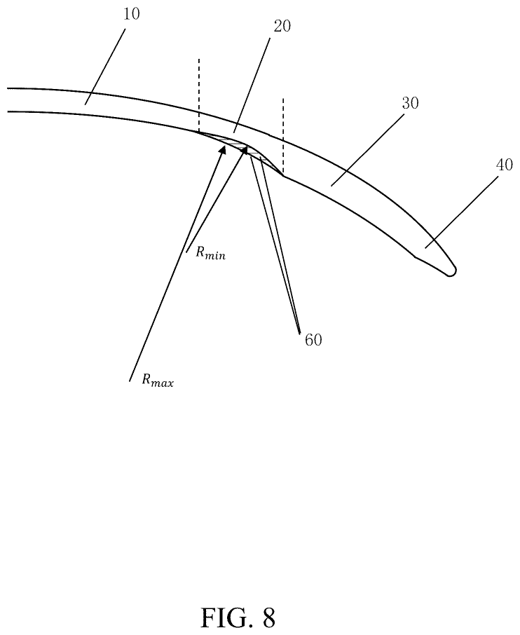

It should be noted that the radial curvature radius is used to reflect steepness of the wave surface. When the radial curvature radius is larger, a corresponding wave surface is flatter. When the radial curvature radius is smaller, a corresponding wave surface is steeper. Referring to FIG. 8, in comparison with a reverse curve zone 20 having a surface with a maximum radial curvature radius, a reverse curve zone 20 having a surface with a minimum radial curvature radius has a larger volume of a cavity, generating a greater negative pressure on an anterior surface of the cornea 100, and more epithelial cells of the cornea 100 are accumulated. Therefore, a defocusing ring having an unevenly distributed defocusing amount is formed at a periphery in a shaped cornea 100, to produce higher-order aberrations for retinal imaging. This improves myopia control effect.

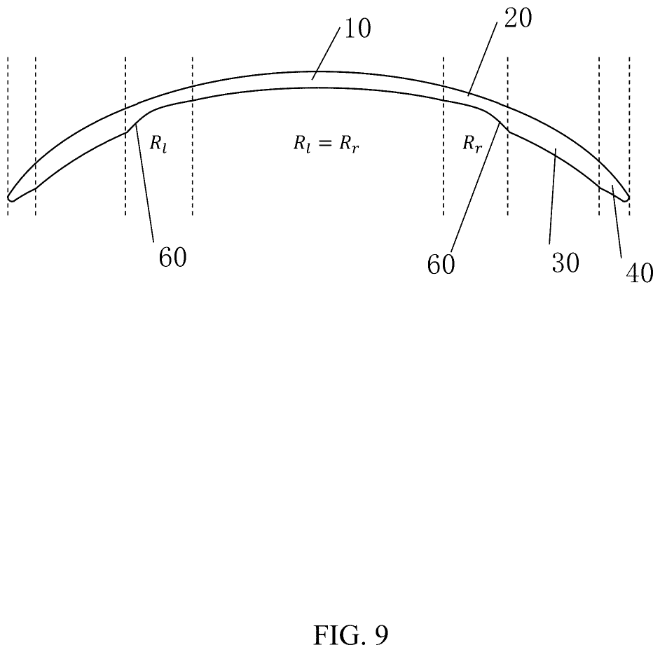

Referring to FIG. 9, in an implementation of this embodiment, when n is even, in any radial profile, a radial curvature radius RI of a left wave surface 60 is equal to a radial curvature radius Rr of a right wave surface 60. This means that the wave surface 60 has symmetry in a radial direction, and thus stress is uniformly distributed.

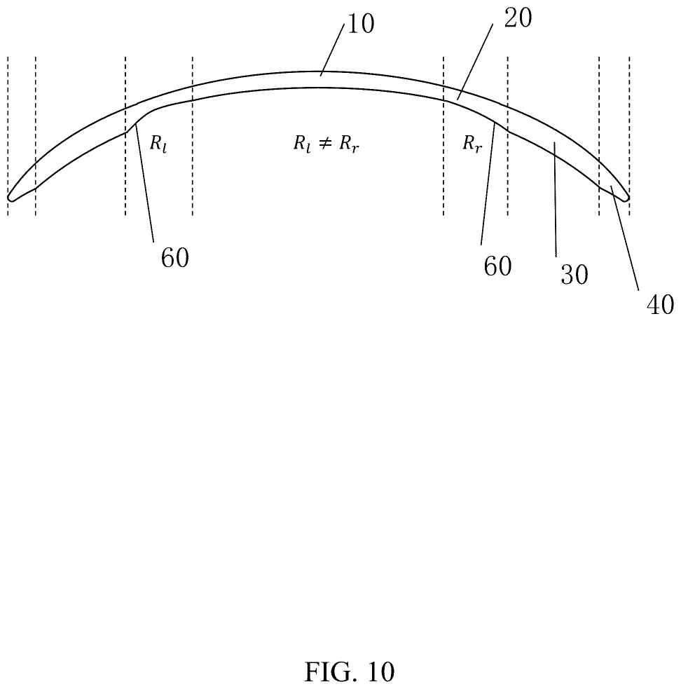

Referring to FIG. 10, in another implementation of this embodiment, when n is odd, in any radial profile, the radial curvature radius RI of the left wave surface 60 is not equal to the radial curvature radius Rr of the right wave surface 60. This means that 60 the wave surface 60 has no symmetry in the radial direction. This helps to produce different pressures in different zones of the cornea, to effectively shape the cornea.

In this specification, the description of “one embodiment”, “some embodiments”, “an example”, “a specific example” and “some examples” means that a specific feature, structure, material or characteristic described in combination with the embodiment(s) or example(s) is included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

The above embodiments merely represent several implementations of the present disclosure, and the descriptions thereof are specific and detailed, but they should not be construed as limiting the patent scope of the present disclosure. It should be noted that those of ordinary skill in the art can further make several variations and improvements without departing from the concept of the present disclosure, and all of these fall within the protection scope of the present disclosure. Therefore, the protection scope of the present disclosure shall be subject to the protection scope defined by the claims.

What is claimed is:

1. An orthokeratology lens, comprising a base curve zone, and a reverse curve zone, an adaptation curve zone, and a peripheral curve zone that are successively formed outward from a periphery of the base curve zone, wherein a space defined between the reverse curve zone and a cornea varies periodically in a circumferential direction, and comprises small spaces and large spaces that are cyclically and alternately disposed.

2. The orthokeratology lens according to claim 1, wherein an outer edge of the base curve zone is a circle, a radial distance from an outer edge of the reverse curve zone to a center point of the base curve zone varies periodically in the circumferential direction, to enable the reverse curve zone to have, in the circumferential direction, narrow edge zones and wide edge zones that are cyclically and alternately disposed, the narrow edge zone defines the small space, and the wide edge zone defines the large space.

3. The orthokeratology lens according to claim 2, wherein a radial width of the reverse curve zone meets the following formula:
$$W R C = \frac{W R C 1 + W R C 2}{2} + \frac{W R C 1 - W R C 2}{2} \cdot cos ( n \cdot θ ) \qquad ( 1 )$$
wherein, WRC represents a radial width of the reverse curve zone at an angle of θ, WRC1 represents a maximum radial width of the reverse curve zone, WRC2 represents a minimum radial width of the reverse curve zone, n represents a number of cycles, and θ represents a radial angle rotated starting from a hour hand of three o'clock along an anticlockwise direction.

4. The orthokeratology lens according to claim 3, wherein n≥1.

5. The orthokeratology lens according to claim 1, wherein an outer edge of the reverse curve zone is a circle, a radial distance from an outer edge of the base curve zone to a center point of the reverse curve zone varies periodically in the circumferential direction, to enable the reverse curve zone to have, in the circumferential direction, narrow edge zones and wide edge zones that are cyclically and alternately disposed, the narrow edge zone defines the small space, and the wide edge zone defines the large space.

6. The orthokeratology lens according to claim 5, wherein a radial width of the reverse curve zone meets the following formula:
$$W R C = \frac{W R C 1 + W R C 2}{2} + \frac{W R C 1 - W R C 2}{2} \cdot cos ( n \cdot θ ) \qquad ( 2 )$$
wherein, WRC represents a radial width of the reverse curve zone at an angle of θ, WRC1 represents a maximum radial width of the reverse curve zone, WRC2 represents a minimum radial width of the reverse curve zone, n represents a number of cycles, and θ represents a radial angle rotated starting from a hour hand of three o'clock along an anticlockwise direction.

7. The orthokeratology lens according to 1, wherein outer edges of the base curve zone and the reverse curve zone are both circles whose center points are coincident with each other, a surface, facing the cornea, of the reverse curve zone is a wave surface, the wave surface has a downtilt surface and an uptilt surface that periodically undulate in the circumferential direction, the downtilt surface defines the small space, and the uptilt surface defines the large space.

8. The orthokeratology lens according to claim 7, wherein a radial curvature radius of the wave surface varies periodically with a change in a circumferential angle.

9. The orthokeratology lens according to claim 8, wherein the radial curvature radius of the wave surface meets the following formula:
$$R ( θ ) = \frac{{R}_{max} + {R}_{min}}{2} - \frac{{R}_{max} - {R}_{min}}{2} \cdot cos ( n \cdot θ ) \qquad ( 3 )$$
wherein, R(θ) represents a radial curvature radius of the wave surface at an angle of θ, Rₘₐₓ represents a maximum radial curvature radius of the wave surface, Rₘᵢₙ represents a minimum radial curvature radius of the wave surface, n represents a number of circles, and θ=[0, 2*π].

10. The orthokeratology lens according to claim 9, wherein n is odd or even.
